(19) United States
(12) Patent Application Publication
(10) Pub. No.: US 2010/0100328 A1
(43) Pub. Date: Apr. 22, 2010

(54) System and Method for Generating a Cloud Type and Coverage Prediction Database

(76) Inventors: John S. Moore, Middleton, WI (US); Chad W. Johnson, Cross Plains, WI (US); Brett A. Wilt, Patriot, OH (US)

Correspondence Address: BOYLE FREDRICKSON S.C., 840 North Plankinton Avenue, MILWAUKEE, WI, 53203, US

(21) Appl. No.: 12/486,474

(22) Filed: Jun. 17, 2009

Related U.S. Application Data
(60) Provisional application No. 61/073,194, filed on Jun. 17, 2008.

(51) Int. Cl. G01W 1/10; G06F 19/00

(52) U.S. Cl. 702/3

(57) ABSTRACT

A method of generating a visually accurate three dimensional cloud type and coverage database. The method includes the steps of receiving current meteorological observations, generating a forecast prediction model based on the current meteorological observations, and generating a visually accurate three dimensional cloud type and coverage database for an area of interest that will approximate the cloud type and coverage that will appear in the area of interest based on the current meteorological observation and the forecast prediction model

### CROSS REFERENCE TO RELATED APPLICATIONS

This application claims priority based on U.S. Provisional Application No. 61/073,194, filed Jun. 17, 2008, the entirety of which is herein incorporated by reference.

### BACKGROUND

There is a continuing demand on the part of the viewing public for more accurate, timely, easily understandable, and entertaining weather reports and forecasts. Viewers of broadcast and cable television weather reports, for example, expect not only to be told what the weather is going to be like in the future, but also to be shown it. And they expect such weather reports to be presented in a dynamic, accurate, and entertaining way.

Most of the data used by a meteorologist or other weather reporter (or automated apparatus) to determine future weather conditions is derived from highly accurate computerized weather forecast models. Examples of such weather forecasting models include the ADONIS and MicroCast weather models, available from Weather Central Inc. of Madison, Wis. These are sophisticated computer-implemented weather forecasting models that employ information on current weather conditions as initial conditions. Such weather forecasting models are able to generate detailed predictions of various weather conditions (e.g., temperature, precipitation, wind speed, severe weather conditions, etc.) having a high degree of geographic and temporal resolution and with significant accuracy. Such high resolution forecast weather condition information is provided for a set of geographical grid areas (i.e., a geographical area divided into defined grid areas), for various atmospheric levels within each grid area (including the Earth's surface and various levels above the surface), and for a series of time periods (e.g., for half hour increments extending several days into the future).

It is known to use the forecast weather information generated by such weather forecast models to generate animated images of forecast weather conditions for use in broadcast and cable television weather reports, Internet website-based weather reports, etc. For example, such modeled weather data may be used to create an animation of predicted precipitation moving through an area that has the appearance of an animated time-lapse radar display that many viewers are familiar with. Such modeled weather data has also been used to select automatically pre-generated or pre-recorded animated sky images to be displayed to viewers as part of such weather reports. For example, if the modeled weather data indicates that clouds and high winds are forecast for a particular location and time, an animated image of clouds moving rapidly across the sky may be selected and presented to the viewers. Such known weather animations, however, take only limited advantage of the data available in current forecast weather models and thus provide animated images of only limited accuracy, relevance, and interest.

It is well known that fractal image generation may be used to create realistic three-dimensional animated cloud images. Such image generation allows the generated cloud animations to be viewed by an observer from any position in virtual space, including in the clouds themselves.

What is desired, however, is an apparatus and method that takes fuller advantage of the weather forecast information provided by current weather forecast models and other information sources that can affect cloud formation and appearance to create a database of realistic forecast sky conditions including cloud image generation. In particular, what is desired is an apparatus and method for generating three-dimensional animations of sky conditions based on a plurality of information inputs. Such cloud image animations may be used as a valuable addition to broadcast and cable television weather report presentations and the like.

### SUMMARY OF THE INVENTION

One embodiment of the invention relates to a method of generating a visually accurate three dimensional cloud type and coverage database. The method includes the steps of receiving current meteorological observations, generating a forecast prediction model based on the current meteorological observations, and generating a visually accurate three dimensional cloud type and coverage database for an area of interest that will approximate the cloud type and coverage that will appear in the area of interest based on the current meteorological observation and the forecast prediction model

Another embodiment of the invention relates to a method of generating a three dimensional cloud type and coverage database. The method includes the steps of receiving current meteorological observations, land/surface data, and cycled forecast data and generating cloud coverage data based on the current meteorological observations, land/surface data, and the cycled forecast data, the cloud coverage data including a cloud fraction and a cloud type.

Another embodiment of the invention relates to a method of generating a three dimensional cloud type and coverage database. The method includes the steps of receiving current meteorological observations, land/surface data, and cycled forecast data, generating a forecast prediction model based on the current meteorological observations, land/surface data, and cycled forecast data, identifying a three dimensional grid representing an area of interest, the grid including a plurality of grid points, generating cloud coverage data for each grid point, the cloud coverage data including a cloud fraction and a cloud type, and generating a three dimensional cloud type and coverage database.

Another embodiment of the inventions relates to a system for generating a three dimensional cloud type and coverage data map. The system includes a cloud prediction processor, the processor including computer readable media and being configured to implement a plurality of steps. The steps include receiving current meteorological observations, generating a forecast prediction based on the current meteorological observations, and generating a cloud type and coverage map based on the forecast prediction, the cloud type including a type of convective cloud or a type of stratus cloud.

Alternative examples and other exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an environment processing system configured to predict both cloud type and coverage using a numerical weather model to generate a fully three dimensional cloud type and cloud coverage dataset, according to an exemplary embodiment; and

FIG. 2 is a flowchart illustrating a method for generating a fully three dimensional cloud type and cloud coverage dataset, according to an exemplary embodiment.

### DETAILED DESCRIPTION OF THE INVENTION

Before describing in detail the particular improved system and method, it should be observed that the invention includes, but is not limited to, a novel structural combination of conventional data/signal processing components and communications hardware and software, and not in particular detailed configurations thereof. Accordingly, the structure, methods, functions, control, and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

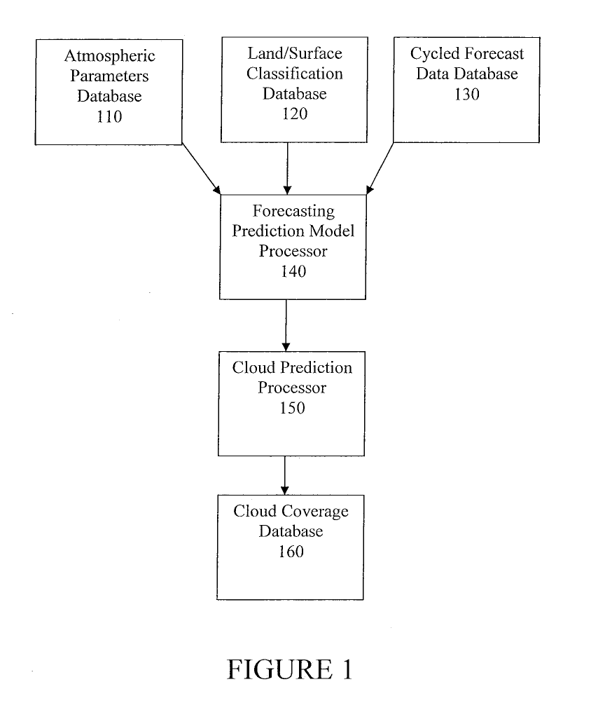

Referring to FIG. 1, a cloud prediction system 100 configured to predict both cloud type and coverage using a numerical weather model to generate a fully three dimensional cloud type and cloud coverage dataset is shown, according to an exemplary embodiment. System 100 includes a current atmospheric parameters database 110, a land/surface classification database 120, a cycled forecast data database 130, a forecasting prediction model processor 140, a cloud prediction processor 150, and a three dimensional cloud type and cloud coverage database 160. Although shown according to a specific embodiment, system 100 may alternatively include more, fewer, and/or different components configured to implement functions described herein.

Atmospheric parameters database 110 may be any type of database configured to receive, store, and allow retrieval of data stored therein. Database 110 is configured to store a base set of current atmospheric data. Current atmospheric data may be data representing current conditions that is updated periodically, such as every six hours. Database 110 may be associated with system 100 or may be an external database, such as atmospheric data generated by the National Center of Atmospheric Prediction (NCEP). Exemplary data stored in database 110 may include, but is not limited to, temperature, relative humidity, geopotential height, U wind component, V wind component, sea surface temperature, snow depth, soil temperature, and soil moisture content. The data may be stored and retrievable on a variety of grids and domains, including, for example, a global latitude/longitude grid.

Land/surface classification database 120 also may be any type of database configured to receive, store, and allow retrieval of data stored therein. Database 120 may be associated with system 100 or may be an external database. Database 120 is configured to store global high-resolution land/surface data available from the United States Geological Survey (USGS). The global land/surface data may be stored and retrievable in a latitude/longitude tiled grid. The data may include, but is not limited to, static data sets such as digital elevation models, land-use classifications, normalized-difference vegetation indices, and soil type classifications.

Cycled forecast data database 130 may also be any type of database configured to receive, store, and allow retrieval of data stored therein. Database 130 may be configured to receive and store cycled forecast data. The cycled forecast data may include a previous short-term forecast that is used to initialize portions of a model run, allowing for native model initializations at much higher resolutions than available from NCEP. The cycle data sets may include, but are not limited to, soil temperature, soil moisture content, frozen soil moisture content, vegetation canopy moisture content, cloud water content, cloud ice content, precipitation tendencies, and turbulent kinetic energy.

Forecasting prediction model processor 140 may be a software application stored on computer readable medium and configured to generate forecasting prediction model output. Forecasting model processor 140 may be configurable such that the forecasting prediction may be generated on both low cost personal computer-based systems and high end platforms. Forecasting model processor 140 may be configured to generate a plurality of parameters for each grid point in a three dimensional grid representing an area of interest. The plurality of parameters may include, but are not limited to, relative humidity, horizontal deformation, vertical deformation, Brunt-Vaisala frequency, convective cloud top, convective cloud base, convective precipitation rate, non-convective precipitation rate, planetary boundary layer height, total mixing ratio, and mixing ratio. The plurality of parameters may be generated based on inputs received from at least databases 110, 120, and 130.

Cloud coverage prediction processor 150 may be a software application stored on computer readable medium and configured to generate forecasting prediction model output based at least in part on the forecasting prediction model output. Cloud coverage prediction processor 150 may be configurable such that the process may be run on both low cost personal computer-based systems and high end platforms. Prediction model processor 110 may be configured to receive inputs from databases 110, 120, and 130 and processor 140 to generate a fully three dimensional cloud type and cloud coverage dataset to be stored in database 160 in accordance with the methods described hereinbelow.

Databases 110-130 and processors 140-150 are described herein as storing and manipulating data stored in a grid format. A grid may be a two or three dimensional box defined by a set number of grid points, depending on the type of data being represented. The box may be used to define an area of interest for which cloud types and coverage are to be generated using system 100. According to an exemplary embodiment, the grid may be defined using scaling in one or more of the grid axes directions. Further, although grids are referred to herein with reference to databases 110-130 and processors 140-150, it is important to recognize that these grids are not necessarily homogenous, extrapolation of data and/or use of prediction models may be utilized when generating the cloud type and coverage prediction.

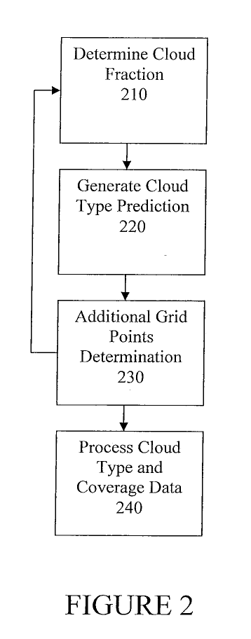

Referring now to FIG. 2, a flowchart 200 illustrating a method for generating a fully three dimensional cloud type and cloud coverage dataset is shown, according to an exemplary embodiment. The method of flowchart 200 may be implemented using system 100, described above with reference to FIG. 1. Although specific steps are shown and described in a specific order, flowchart 200 may alternatively include more, fewer and/or a different ordering of steps to implement the functionality described herein.

The steps of flowchart 200 may be implemented at each horizontal and vertical model grid point. Flowchart 200 utilizes convective input parameters to simulate atmospheric processes that occur on scales much smaller than a parent model grid. Utilizing convective input parameters, the effects of small-scale processes, such as a thunderstorm, may be accounted for and allowed to interact with larger scale processes. A cloud prediction algorithm may also use simple parameterization to dramatically improve the forecasts of cloud types and coverage through the use of relative humidity model output data.

In a step 210, for a first point in the grid defining the area of interest, a cloud fraction is determined. The cloud fraction is the percent of sky and/or a grid box containing clouds. According to an exemplary embodiment, step 210 may use either of two methods to determine the cloud fraction any point in the model domain. The first method includes using explicit microphysical data generated by prediction model processor 140 as described in further detail herein. If explicit clouds are not detected within the output generated by prediction model processor 140, a cloud fraction parameterization may be used to detect potential clouds on a sub-grid scale, as is also described in further detail herein. If the output generated by prediction model processor 140, convective parameterization, and relative humidity parameterizations do not indicate fractional cloud cover, then no clouds are assumed for the particular grid point and flowchart 200 is repeated for a next grid point within the area of interest in a step 230.

If a fractional cloud cover is detected, the calculated cloud fraction parameter is sent to a cloud type algorithm, along with a previously defined list of cloud prediction input parameters, to generate a cloud type prediction in a step 220. In step 220, a process of elimination, described in further hereinbelow, may be used in conjunction with the pre-defined cloud type definitions to derive a three dimensional cloud type data set. Step 220 may be utilized for each grid point in an area of interest to derive a pre-defined cloud type including identification of a cloud type from the set of cloud types including, but not limited to, cumulonimbus incus, cumulonimbus calvus, towering cumulus, cumulus congestus, cirrocumulus, altocumulus, anvil, nimbostratus, cirrostratus, cirrus, altostratus, and stratus types.

Following cloud type determination and/or determination that no clouds are to be assumed, a next grid point in the area of interest is examined in a step 230 to iteratively analyze each grid point. Following the determination of cloud type and cloud fraction for every grid point in the area of interest, a step 240 may be implemented to “digest down” the cloud output from the model to a list of clouds at each grid point in an X/Y space. The base elevation of the cloud and its depth and the cloud direction and speed is also determined. The output from the method of flowchart 200 may be a remap of the original model domain into a secondary domain such as, but not limited to, a configurable pseudo-Mercator grid.

Advantageously, a cloud prediction dataset may be used to predict clouds coverage and cloud type for an extended period of time, such as 14 days. Cloud information may be utilized in a variety of industries, such as the airline or other transport industry for analyzing routing options, the solar power industry for calculating power generation, the computer gaming and/or pilot training industry for providing “live” or “future live” flying conditions for use in flight simulation applications, etc.

While the detailed drawings, specific examples and particular formulations given described preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of forecasting model, size of the forecasting grid, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

We claim:

1. A method of generating a visually accurate three dimensional cloud type and coverage database, comprising the steps of:
(a) receiving current meteorological observations;
(b) generating a forecast prediction model based on the current meteorological observations; and
(c) generating a visually accurate three dimensional cloud type and coverage database for an area of interest that will approximate the cloud type and coverage that will appear in the area of interest based on the current meteorological observation and the forecast prediction model.

2. A method of generating a three dimensional cloud type and coverage database, comprising the steps of:
(a) receiving current meteorological observations, land/surface data, and cycled forecast data; and
(b) generating cloud coverage data based on the current meteorological observations, land/surface data, and the cycled forecast data, the cloud coverage data including a cloud fraction and a cloud type.

3. A method of generating a three dimensional cloud type and coverage database, comprising the steps of:
(a) receiving current meteorological observations, land/surface data, and cycled forecast data;
(b) generating a forecast prediction model based on the current meteorological observations, land/surface data, and cycled forecast data;
(c) identifying a three dimensional grid representing an area of interest, the grid including a plurality of grid points;
(d) generating cloud coverage data for each grid point, the cloud coverage data including a cloud fraction and a cloud type; and
(d) generating a three dimensional cloud type and coverage database.

4. The method of claim 3, wherein the cloud fraction is determined based on microphysical data included in the forecast prediction model.

5. The method of claim 4, wherein the cloud fraction is determined based on a cloud fraction parameterization where no clouds are detected based on the forecast prediction model.

6. The method of claim 3, wherein the cloud type is determined based on the cloud fraction and utilizing a process of elimination.

7. The method of claim 6, where determining a cloud type includes an initial determination of whether the cloud type is a type of convective cloud or a type of stratus cloud.

8. A system for generating a three dimensional cloud type and coverage data map, comprising:
a cloud prediction processor, the processor including computer readable media and being configured to implement a plurality of steps including
(a) receiving current meteorological observations;
(b) generating a forecast prediction based on the current meteorological observations; and
(c) generating a cloud type and coverage map based on the forecast prediction, the cloud type including a type of convective cloud or a type of stratus cloud.

9. The system of claim 8, wherein generating cloud coverage data for each grid point includes generating a cloud fraction and a cloud type for each grid point.

10. The system of claim 9, wherein the cloud fraction is determined based on microphysical data included in the forecast prediction model.

11. The method of claim 10, wherein the cloud fraction is determined based on a cloud fraction parameterization where no clouds are detected based on the forecast prediction model.

12. The method of claim 9, wherein the cloud type is determined based on the cloud fraction and utilizing a process of elimination.

13. The method of claim 12, where determining a cloud type includes an initial determination of whether the cloud type is a type of convective cloud or a type of stratus cloud.
